(19) United States
(12) Patent Application Publication
(10) Pub. No.: US 2012/0049462 A1
(43) Pub. Date: Mar. 1, 2012

(54) CONNECTOR SEAL

(76) Inventor: Malcolm Pitman, Aberdeen (GB)

(21) Appl. No.: 13/148,909

(22) PCT Filed: Feb. 12, 2010
(86) PCT No.: PCT/GB2010/000253

§ 371 Date: Nov. 14, 2011

(30) Foreign Application Priority Data
Feb. 14, 2009 (GB) 0902506.5

(51) Int. Cl. F16J 15/14; F16L 15/04

(52) U.S. Cl. 277/314; 277/627

(57) ABSTRACT

A connector seal (10) is adapted to be provided on a connector (24, 26) between first and second components (16, 18). The connector seal comprises particles of a swellable material (12) configured to swell upon exposure to a swelling activator to provide improved sealing integrity at or within the connector (24, 26). In one disclosed embodiment the connector seal (10) is configured for use on a threaded connector (24, 26) between two oilfield tubulars (16, 18).

### FIELD OF THE INVENTION

The present invention relates to a connector seal suitable for use in a connector, such as a connector between tubular bodies.

### BACKGROUND TO THE INVENTION

In many industries, such as in the oil and gas industry, conduits are formed by joining together pipes in end-to-end relation using suitable connectors, for example threaded connectors. In the specific field of oil and gas, tubing strings, such as production strings, drilling strings, casing strings or the like are formed by coupling together individual pipe lengths. However, the location of the connectors is often a source of leakage either into or out of the conduit. Leakage may occur due to, for example, manufacturing tolerances, misalignment of connector components, such as threads, foreign objects trapped within the connector, corrosion, fatigue, thermal dynamic expansion during prolonged use, change of use, increased external or internal pressures, cross threading or the like.

There is therefore a desire in the art to minimise leakage at the connectors. This may be achieved by seeking to ensure more accurate manufacturing tolerances, employing complex thread designs or the like, which can significantly increase manufacturing costs. It is also known in the art to utilise compounds which are coated on mating features of a connector, such as mating threads, in order to improve seal integrity. Such compounds are typically a combination of a lubricant medium which carries metallic materials, such as zinc, lead, copper or the like. Epoxy based sealing substances or glues are also used in some applications.

However, such known compounds may have limited effect in many circumstances, such as where large tolerances exist, threads have been crossed, damaged or the like. Additionally, leakage at a connector may still occur where an incorrect compound has been selected for the particular application, too much compound has been used, insufficient compound has been used, or the like.

### SUMMARY OF THE INVENTION

According to a first aspect of the present invention there is provided a connector seal comprising particles of a swellable material configured to swell upon exposure to a swelling activator.

The connector seal may be configured to be applied to at least a portion of a connector. For example, a connector may comprise two or more components, wherein the connector seal may be applied to at least one of the components. The connector seal may be configured to be applied before, during or after the components are connected together.

In use, the connector seal may be provided on a connector between at least first and second components, wherein the particles of swellable material within the connector seal swell upon contact with a swelling activator. Such swelling may provide improved sealing integrity at or within the connector. For example, the particles may swell to fill any gaps, leak paths or the like within the connector.

The particles of swellable material may be configured to be directly applied to a connector.

The particles of swellable material may be configured to be combined with a support component, medium or the like prior to, during or after being applied to a connector.

The connector seal may comprise a support component adapted to support, contain or otherwise hold at least a portion of the particles of swelling material.

The support component may comprise a fluid material. The swellable particles may be suspended within the fluid material. This arrangement may permit the connector seal to be coated on a connector, for example by spreading or the like. The fluid support may permit the connector seal to be sprayed on a connector, for example via an atomizer or the like. The fluid material may facilitate lubrication, for example while connecting at least first and second components together.

The fluid support may comprise mineral oil, grease, water or any other liquid chemical or chemical composition or the like.

The support may comprise a substrate, wherein the swellable particles may be mounted on or within the substrate. In this arrangement the substrate carrying the swellable particles may be configured to be mounted on a connector. The substrate may be formed and arranged to correspond to the shape of the connector. The substrate may be configured to comply to the shape of the connector when applied thereto or mounted thereon. At least a portion of the substrate may be rigid, flexible, elastic, in-elastic or the like. The substrate may be provided in tape or sheet form and configured to cover a connector, such as by being wrapped around the connector.

The support component may comprise a container adapted to contain particles of swellable material. The container may be configured to be applied to or otherwise mounted on a connector. The container may be configured to permit release of the swellable particles, for example when connection is made at the connector. For example, the process of connection may rupture the container to release the swelling particles.

The container may function to isolate the particles from a swelling activator. In this way, the swelling particles may only become exposed to a swelling activator when released form the container.

The container may be configured to contain at least a portion of the swellable particles while said particles are caused to swell. The container may be expandable to accommodate swelling of the particles. The container may be adapted to receive a medium adapted to cause the swellable particles to swell.

The support component may comprise or be defined by a portion of a connector. In one arrangement a portion of a connector may be adapted to contain a quantity of swelling particles. For example, a connector may comprise a chamber filled with swellable particles. In this arrangement the particles may be released when a connection is made using the connector.

The particles of swellable material may be of uniform size. Alternatively, the particles may be of varying sizes.

The connector seal may comprise swellable particles configured to swell when exposed to a common swelling activator. Alternatively, the connector seal may comprise swellable particles which swell upon exposure to different swelling activators. This may permit swelling and sealing integrity to be achieved in various media or conditions, without requiring specific analysis of ambient conditions and tailored selection of particles for use in the connector.

The swellable particles may be configured to swell when exposed to a chemical activator, thermodynamic activator, fluid dynamic activator or the like, or any suitable combination thereof. For example, the swellable particles may be adapted to be activated by a fluid, such as water, hydrocarbons, cement, drilling mud or the like, or any suitable combination thereof. Alternatively, or additionally, the swellable particles may be adapted to be activated by temperature, pressure, sound, radiation or the like.

The connector seal may comprise a swelling activator. In one arrangement at least some of the swellable particles may be configured to be activated by exposure to a support component of the connector seal. For example, the connector seal may comprise a fluid support component, wherein at least a portion of the swellable particles may be configured to swell upon exposure to said fluid support component.

The swellable particles may be configured to be activated to swell upon exposure to a fluid which engages the connector when in use.

The connector seal may be configured for use with a tubing connector which provides a connection between two or more tubulars. In this arrangement the connector seal may be adapted to provide improved sealing integrity at or within the connector to prevent or at least minimise leakage to and/or from the tubulars at the location of the connector.

In embodiments where the connector seal is configured for use with a tubing connector, the swellable particles may be adapted to swell upon exposure to a medium contained within or being communicated through the tubing connector.

The connector seal may be adapted for use on a threaded connector. For example, the connector seal may be configured to be provided at the location of inter-engaging male and female threads of a threaded connector.

The connector seal may be adapted for use on a quick-connect type connector, clamp connector, interference connector, flange connector or the like.

The connector seal may be configured to function as a gasket at a connection between separate components.

The connector seal may be configured to be located on at least part of a connector prior to connection, at the time of connection, or after connection has been made.

The connector seal may be configured for use in the oil and gas industry. For example, the connector seal may be configured for use at a connector between two or more wellbore tubulars, such as drilling tubulars, casings tubulars, production tubulars or the like. The connector seal may be for use with a pin and box type threaded connector.

The swellable particles may comprise an elastomer material, such as a natural or synthetic elastomer material.

According to a second aspect of the present invention there is provided a method of sealing a connector, said method comprising the step of applying a connector seal comprising particles of a swellable material to the connector, and exposing the connector seal to an activator to cause the particles to swell.

The connector seal may be provided in accordance with the first aspect, and may be used as identified above.

According to a third aspect of the present invention there is provided a connector component comprising a connector seal according to the first aspect.

The connector component may be mounted on an element, such as a tubular element. The connector component may comprise connector threads or the like.

According to a fourth aspect of the present invention there is provided a tubular body comprising a connector component and a connector seal according to the first aspect applied to the connector component.

The tubular body may be adapted to be coupled to a separate component, such as a second tubular body, via the connector component.

### BRIEF DESCRIPTION OF THE DRAWINGS

These and other aspects of the present invention will now be described, by way of example only, with reference to the accompanying drawings, in which:

FIG. 1 is a diagrammatic representation of a connector seal in accordance with an embodiment of the present invention;

FIG. 2 is a diagrammatic representation of first and second tubular bodies being connected by a connector which incorporates the connector seal of FIG. 1;

FIG. 3 is an enlarged cross-sectional view of the first and second tubular bodies of FIG. 2 shown in a connected state;

FIG. 4 is a diagrammatic view of a connector seal according to an embodiment of the present invention;

FIG. 5 is a cross-sectional view of a portion of a connector with the connector seal of FIG. 4 applied thereto;

FIG. 6 is a cross-sectional view of a portion of a connector which incorporates a connector seal; and

FIG. 7 is a cross-sectional view of quick-connect type connector which includes a connector seal.

### DETAILED DESCRIPTION OF THE DRAWINGS

FIG. 1 is a diagrammatic view of a portion of a connector seal, generally identified by reference numeral 10, in accordance with an embodiment of the present invention. The connector seal 10 comprises a plurality of particles of swellable material 12 suspended or held in a support medium 14. In the embodiment shown the support medium 14 is a fluid, specifically a lubricant which is mixed with the swellable particles 12. The particles 12 are of varying sizes, but in alternative embodiments may be of a uniform size.

The swellable particles 12 are selected to swell upon exposure to a swelling activator. In the embodiment shown the swelling activator comprises the fluid support medium 14, although, as noted in further detail below, the particles 12 may be selected to swell upon exposure to different swelling activators. As the particles 12 are selected to swell when exposed to the support fluid 14, it is intended for the particles 12 and support fluid 14 to be mixed together shortly before being applied to a connector.

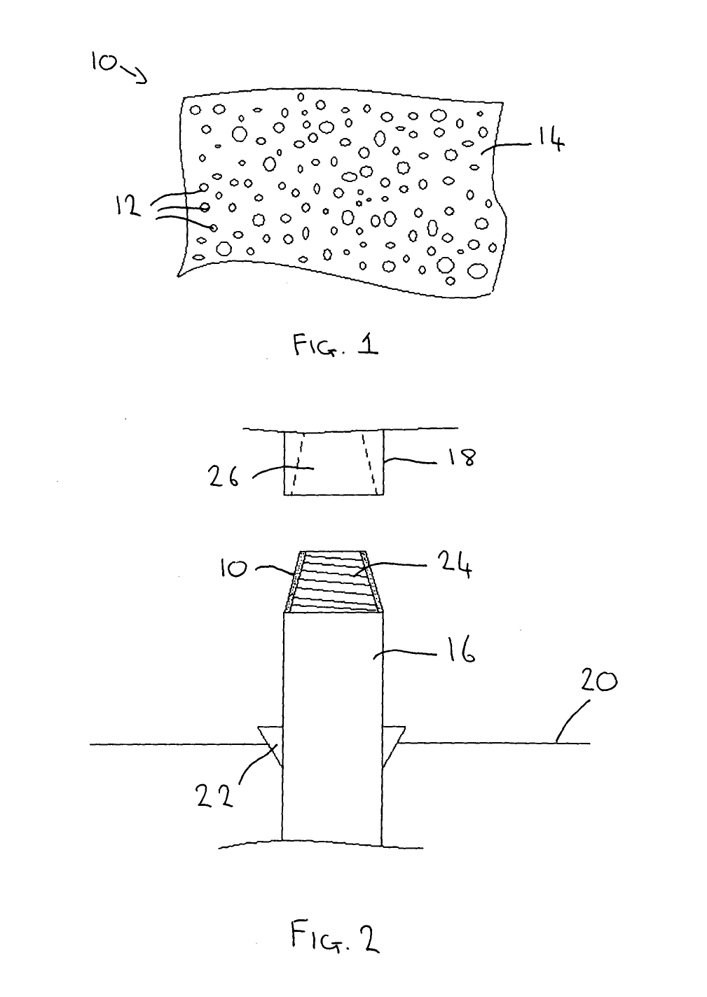

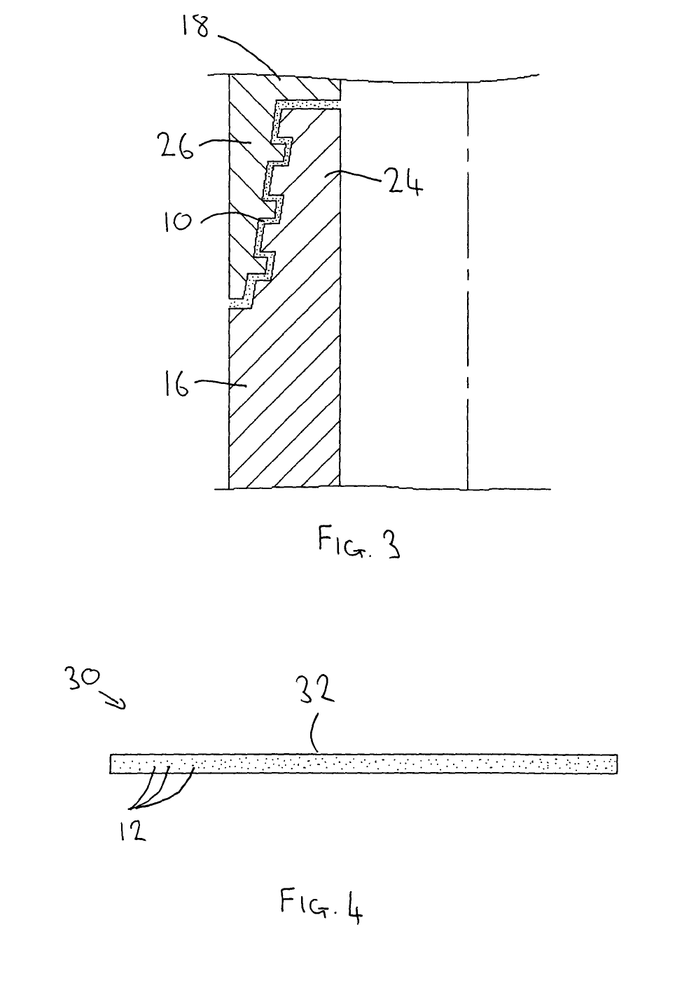

The connector seal 10 may be used in a variety of applications. An exemplary use within a threaded connector between first and second tubulars 16, 18 is illustrated in FIG. 2, reference to which is now made. The tubulars 16, 18 are wellbore tubulars and are shown prior to being connected together. In this respect the lower tubular 16 is suspended from a platform 20 via slips 22 in a conventional manner, and the upper tubular 18 is suspended via lifting equipment (not shown) from above. The lower tubular 16 includes a male or pin threaded connection portion 24 at an upper end thereof, and the upper tubular 18 includes a female or box threaded connection portion 26 at a lower end thereof. The tubulars 16, 18 are coupled together by engaging the pin and box threaded connectors 24, 26 and tightening to a required torque.

The connector seal 10 is shown applied to the pin connector 24, which may be achieved by spreading, spraying or the like, prior to making the connection. The connector seal 10 may alternatively or additionally be applied to the box connector 26. Once sufficient connector seal has been applied the pin and box connectors 24, 26 may be engaged. The connector seal 10, and particularly the fluid support 14 may assist to lubricate and ease engagement and tightening of the connection.

An enlarged partial cross-sectional view of the tubulars 16, 18 when connected together is shown in FIG. 3. As shown, the connector seal 10 has expanded by swelling of the particles 12 within the fluid support 14 to fill the gaps between the pin and box threaded connectors 24, 26, thus assisting to establish a high-quality seal at the connection.

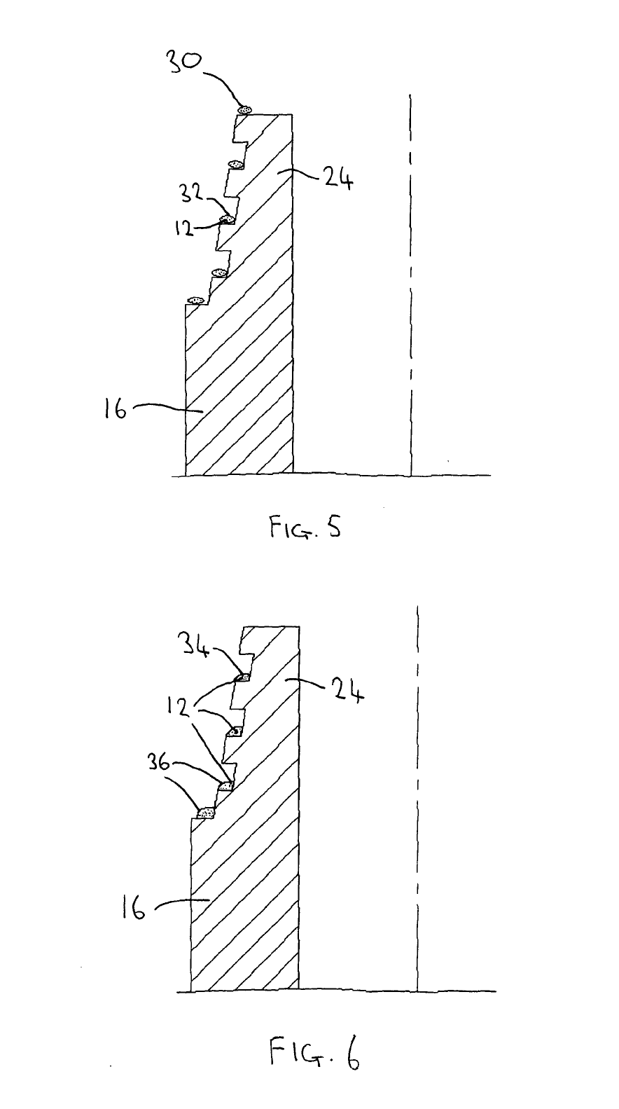

An alternative arrangement of a connector seal, in this case generally designated by reference numeral 30, is shown in FIG. 4. The connector seal 30 comprises a support in the form of a tubular container 32 which contains a number of swellable particles 12. In use, the connector seal 30 may be applied to a connector and the particles released to provide a seal. Such a use is shown in FIG. 5 in which the connector seal 30 is wound around a threaded pin connector 24 of a tubular 16. When the pin connector 24 is engaged with a box connector (not shown), the container 32 of the seal connector 30 may be ruptured to release the swellable particles 12. When exposed to a swelling activator (such as a fluid being communicated through the tubular 16) the swellable particles will swell and expand to create a seal at the connector.

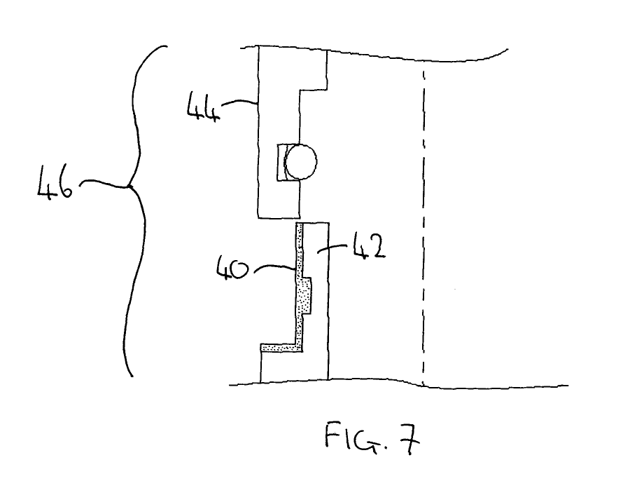

A further alternative embodiment is shown in FIG. 6, reference to which is now made. In this embodiment a connector seal 34 is provided integrally with a threaded pin connector 24 of a tubular 16. Specifically, the pin connector includes a number of integrated pockets 36 which are filled with swellable particles 12. When the pin connector 24 is engaged with a box connector (not shown), the swellable particles 12 may be released to subsequently create a seal at the connector.

Connector seals according to various embodiments of the present invention have been described above in use within a threaded connection. However, the present invention is not limited for such a use. For example, a connector seal according to the present invention may be used in a quick-connect type connection, such as is shown in FIG. 7. In this example a connector seal 40 according to an embodiment of the present invention is applied to become disposed between male and female portions 42, 44 of a quick-connect coupling.

It should be understood that the embodiments described above are merely exemplary and that various modifications may be made thereto without departing from the scope of the invention. For example, the connector seal may be formed primarily of swellable particles which may be applied directly to a connector (i.e., without a support). Additionally, a support for the swellable particles may be in the form of a substrate type structure. The substrate structure may be capable of being wound around or otherwise mounted on a connector.

Also, the swellable particles may be configured to swell upon exposure to a medium within which a connector is used. Further, the swellable particles may be configured to swell when exposed to a medium being carried by connected tubulars. In these arrangements leak paths at the connector may be immediately, or nearly immediately repaired.

The seal connector may comprise particles which swell up exposure to different swelling activators.

1. A connector seal comprising granules of a swellable material configured to swell upon exposure to a swelling activator, and adapted to be provided on a connector between at least first and second components.

2. The connector seal according to claim 1, configured to be applied to at least a portion of a connector.

3. The connector seal according to claim 1, comprising a support component adapted to support, contain or otherwise hold at least a portion of the granules of swelling material.

4. The connector seal according to claim 3, wherein the support component comprises a fluid material.

5. The connector seal according to claim 3, wherein the support component comprises a lubricant.

6. The connector seal according to claim 3, wherein the support component comprises a substrate, wherein the swellable granules are mounted on or within the substrate.

7. The connector seal according to claim 3, wherein the support component comprises a container adapted to contain granules of swellable material.

8. The connector seal according to claim 7, wherein the container is configured to permit release of the swellable granules.

9. The connector seal according to claim 3, wherein the support component is at least partially defined by a portion of a connector.

10. The connector seal according to claim 1, comprising swellable granules configured to swell when exposed to a common swelling activator.

11. The connector seal according to claim 1, comprising swellable granules configured to swell upon exposure to different swelling activators.

12. The connector seal according to claim 1, wherein the swellable granules are adapted to be activated by a fluid including at least one of water, hydrocarbons, cement and drilling mud.

13. The connector seal according to claim 1, comprising a swelling activator.

14. The connector seal according to claim 13, wherein the swelling activator is defined by a support component.

15. The connector seal according to claim 1, wherein the swellable granules are configured to be activated to swell upon exposure to a fluid which engages an associated connector when in use.

16. The connector seal according to claim 1, configured for use with a tubing connector which provides a connection between two or more tubulars.

17. The connector seal according to claim 16, wherein the swellable granules are adapted to swell upon exposure to a medium contained within or being communicated through the tubing connector.

18. The connector seal according to claim 1, adapted for use on a threaded connector.

19. The connector seal according to claim 1, configured to function as a gasket at a connection between separate components.

20. The connector seal according to claim 1, configured to be located on at least part of a connector prior to connection, at the time of connection, or after connection has been made.

21. A method of sealing a connector, said method comprising the step of applying a connector seal comprising granules of a swellable material to the connector, and exposing the connector seal to an activator to cause the granules to swell.

22. A connector component comprising a connector seal according to claim 1.

23. A tubular body comprising a connector component and a connector seal according to claim 1 applied to the connector component.

24. The tubular body according to claim 23, adapted to be coupled to a separate component via the connector component.

25. A thread connector seal for use with a threaded connector between first and second components, comprising:
a support medium; and
a plurality of granules of a swellable material suspended within the support medium, wherein the swellable granules are configured to swell upon exposure to a swelling activator.
